(19) United States
(12) Patent Application Publication
(10) Pub. No.: US 2023/0381752 A1
(43) Pub. Date: Nov. 30, 2023

(54) METAL OXIDE-COATED TERNARY CATALYST AND PREPARING METHOD OF THE SAME

(71) Applicant: RESEARCH & BUSINESS FOUNDATION SUNGKYUNKWAN UNIVERSITY, Suwon-si (KR)

(72) Inventors: Jong Wook BAE, Suwon-si (KR); Jae Min PARK, Ansan-si (KR); Ji Su YU, Seoul (KR)

(73) Assignee: RESEARCH & BUSINESS FOUNDATION SUNGKYUNKWAN UNIVERSITY, Suwon-si (KR)

(21) Appl. No.: 18/307,317

(22) Filed: Apr. 26, 2023

(30) Foreign Application Priority Data
Apr. 28, 2022 (KR) 10-2022-0052479

(51) Int. Cl. B01J 23/83; B01J 35/00; B01J 23/78; B01J 21/02; B01J 37/04; B01J 37/00; B01J 21/06; B01J 21/08; B01J 21/04

(52) U.S. Cl. CPC B01J 23/83; B01J 35/0006; B01J 23/78; B01J 21/02; B01J 37/04; B01J 37/0018; B01J 21/066; B01J 21/08; B01J 21/04

(57) ABSTRACT

The present disclosure relates to a ternary catalyst coated with a metal oxide, the ternary catalyst including: a ternary catalyst core including a hydrotalcite support and metal particles dispersed on the support; and a metal oxide shell formed on the ternary catalyst core.

### CROSS-REFERENCE TO RELATED APPLICATIONS

This application claims the benefit under 35 USC § 119(a) of Korean Patent Application No. 10-2022-0052479, filed on Apr. 28, 2022, in the Korean Intellectual Property Office, the entire disclosure of which is incorporated herein by reference for all purposes.

### BACKGROUND OF THE INVENTION

### 1. Field of the Invention

The present disclosure relates to a ternary catalyst coated with a metal oxide and a method for manufacturing the same.

### 2. Description of the Related Art

As energy environments change, and concerns about climate change and global warming increase, interest in developing hydrogen economy is increasing. While clean hydrogen production by water splitting is still energy-intensive and uneconomical, methane and carbon dioxide included in a gaseous fuel such as a natural gas, a shale gas, or a biogas may be raw materials that are more economical for the hydrogen production. Dry reforming of methane using CO₂ as an oxidizing agent corresponds to a reaction of producing a synthesis gas including a mixture of H₂ and CO, which has received considerable attention for economic and environmental benefits thereof. The dry reforming consumes two major greenhouse gases, that is, CO₂ and CH₄ so as to produce a hydrogen source for a fuel cell, a fuel for a gas engine, or a synthesis gas that may be used to produce a high value-added chemical through an FT reaction.

Despite advantages of a dry reforming reaction, there is a problem that a catalyst used in the reaction is easily deactivated. Therefore, in order to solve the problem, a major challenge is to develop a stable catalyst that may not be easily deactivated.

The main reason for the deactivation of the catalyst is shortening of a useful life of a catalyst caused by deposition of coke or inactive carbonaceous species that may block an active site or clog a reactor. In general, noble metals such as Pt, Ru, Ir, and Rh and transition metals such as Ni, Cu, Co, and Fe have activity for the dry reforming of methane, and a catalyst based on nickel among the metals is cheaper than a noble metal catalyst, so that the nickel-based catalyst is economically preferred. However, the nickel-based catalyst has a very high tendency to form coke under a dry reforming condition, so that there are limitations in applying the nickel-based catalyst to a prolonged reaction.

Apart from selection of a metal, other factors contributing to the deposition of coke on a surface of the catalyst are a reaction condition, and a structure and a composition of the catalyst. Several researches have reported that formation of coke is reduced at high reaction temperatures (>800° C.) and high CO₂/CH₄ ratios.

A side reaction mainly contributing to the formation and deposition of coke includes a methane decomposition reaction (CH₄→>C(s)+2H₂) and a Boudouard reaction (2CO↔C(s)+CO₂). Since the Boudouard reaction is an exothermic reaction having a low equilibrium conversion rate at high temperatures (>800° C.), the coke formed on the surface at temperatures exceeding 800° C. is produced mainly by the methane decomposition reaction. Carbon formed by the methane decomposition reaction may have relatively higher activity, and may be easily gasified by CO₂. Therefore, a reaction at high temperatures (>800° C.) may be more effective in inhibiting the formation of coke and increasing a conversion rate in the dry reforming reaction, which is an endothermic reaction.

Accordingly, extensive researches have been conducted on design of a Ni-based catalyst having resistance against coke for the dry reforming. Some approaches that have improved the resistance against coke are to increase a metal-support interaction in a catalyst, to dope a basic metal oxide, and to introduce a second metal for a synergy effect of a bimetal.

However, a general catalyst in which nickel particles are dispersed on a surface of a support as described above may not fundamentally suppress catalyst activity reduction and carbon deposition, which are caused by agglomeration that occurs as the nickel particles move on the surface at high temperatures.

Therefore, there is a demand to develop a catalyst having high reactivity and durability against coke by preventing sintering of nickel particles and deposition of coke under reaction conditions of dry reforming of methane and carbon dioxide performed at high temperatures (>800° C.) and a high space velocity.

Korean Patent Registration No. 10-0991263 relates to a nickel-based catalyst for a mixed reforming reaction that simultaneously reforms a natural gas into water vapor and carbon dioxide. Although the above patent discloses a nickel-based catalyst in which Ni is supported as an active component on a Mg—Al metal oxide support, formation of a metal oxide shell on a surface of a catalyst to have high reactivity and durability against coke has not been mentioned in the patent.

### SUMMARY OF THE INVENTION

To solve the problems of the related art described above, an object of the present disclosure is to provide a ternary catalyst coated with a metal oxide, capable of significantly suppressing deactivation of the catalyst by suppressing agglomeration of metal particles, which are active materials, under dry reforming reaction conditions of a high temperature and a high space velocity.

In addition, an object of the present disclosure is to provide a method for manufacturing the ternary catalyst coated with the metal oxide.

In addition, an object of the present disclosure is to provide a catalyst for manufacturing a synthesis gas, which includes the ternary catalyst coated with the metal oxide.

However, technical objects to be achieved by embodiments of the present disclosure are not limited to the above-described technical objects, and other technical objects may exist.

As technical solutions for achieving the technical objects described above, according to a first aspect of the present disclosure, there is provided a ternary catalyst coated with a metal oxide, the ternary catalyst including: a ternary catalyst core including a hydrotalcite support and metal particles dispersed on the support; and a metal oxide shell formed on the ternary catalyst core.

According to one embodiment of the present disclosure, the metal particles may be present between the support and the metal oxide shell, but the embodiments are not limited thereto.

According to one embodiment of the present disclosure, the metal oxide shell may include a pore having a size of less than 20 nm, but the embodiments are not limited thereto.

According to one embodiment of the present disclosure, the metal may include a metal selected from the group consisting of Ni, Cu, Co, Fe, Pt, Ru, Ir, Rh, and combinations thereof, but the embodiments are not limited thereto.

According to one embodiment of the present disclosure, the metal oxide may include a ceramic material selected from the group consisting of ceria (CeO₂), zirconia (ZrO₂), silica (SiO₂), alumina (Al₂O₃), titania (TiO₂), and combinations thereof, but the embodiments are not limited thereto.

In addition, according to a second aspect of the present disclosure, there is provided a method for manufacturing a ternary catalyst coated with a metal oxide, the method including: preparing a ternary catalyst core including a hydrotalcite support and metal particles dispersed on the support; and forming a metal oxide shell on the ternary catalyst core.

According to one embodiment of the present disclosure, the preparing of the ternary catalyst core may include: preparing a mixed solution by dropping a metal precursor aqueous solution onto a basic aqueous solution; preparing powder by drying the mixed solution; and firing the powder, but the embodiments are not limited thereto.

According to one embodiment of the present disclosure, the dropping may be performed under a basic condition, but the embodiments are not limited thereto.

According to one embodiment of the present disclosure, the metal precursor aqueous solution may include precursors of at least three metals selected from Al, Mg, Ni, Cu, Co, Fe, Pt, Ru, Ir, or Rh, but the embodiments are not limited thereto.

According to one embodiment of the present disclosure, the basic aqueous solution may be selected from the group consisting of sodium carbonate, calcium carbonate, magnesium carbonate, calcium hydroxide, magnesium hydroxide, barium hydroxide, potassium hydroxide, and combinations thereof, but the embodiments are not limited thereto.

According to one embodiment of the present disclosure, the firing may be performed for 1 hour to 6 hours within a temperature range of 600° C. to 1,000° C., but the embodiments are not limited thereto.

According to one embodiment of the present disclosure, the forming of the metal oxide shell may include: attaching a surfactant onto a surface of the ternary catalyst core; stirring the ternary catalyst core to which the surfactant is attached with a metal oxide precursor; and removing the surfactant, but the embodiments are not limited thereto.

According to one embodiment of the present disclosure, the surfactant may include a surfactant selected from the group consisting of cetyl trimethyl ammonium bromide, hexadecyl trimethyl ammonium bromide, cetyl trimethyl ammonium chloride, cetyl pyridinium chloride, benzalkonium chloride, benzethonium chloride, dioctadecyl dimethyl ammonium bromide, and combinations thereof, but the embodiments are not limited thereto.

According to one embodiment of the present disclosure, the metal oxide precursor may include a compound represented by Chemical Formula 1:

M-(ORₓ)_{y},
where M is Ce, Zr, Si, Al, or Ti,
x and y are numbers determined by an oxidation number of M,
R is optionally substituted linear or branched C₁-C₁₂ alkyl, optionally substituted C₃-C₁₂ cycloalkyl, or optionally substituted C₆-C₁₈ aryl, and
the substitution is performed by oxygen, nitrogen, sulfur, linear or branched C₁-C₆ alkyl, C₆-C₂₀ aryl, halogen, alkoxy, trimethyl silyl, ether, or a combination thereof, but the embodiments are not limited thereto.

In addition, according to a third aspect of the present disclosure, there is provided a catalyst for manufacturing a synthesis gas, the catalyst including a ternary catalyst coated with a metal oxide according to the first aspect of the present disclosure.

Since the technical solutions described above have been provided for illustrative purposes only, the technical solutions are not to be construed as having intent to limit the present disclosure. Additional embodiments other than the exemplary embodiments described above may exist in the drawings and the detailed description of the invention.

According to the ternary catalyst coated with the metal oxide of the present disclosure, a catalyst prepared from a hydrotalcite precursor may be coated with various metal oxides such as ceria, zirconia, silica, and alumina so as to achieve a space confinement effect, so that deactivation of the catalyst caused by deposition of coke can be significantly suppressed by preventing agglomeration of metal particles (e.g., nickel particles), which are active materials, under dry reforming reaction conditions of a high temperature and a high space velocity.

In addition, a catalyst having resistance against coke while ensuring high conversion rates for methane and carbon dioxide through a unique activity enhancement effect of the coated metal oxide can be provided.

However, effects of the present disclosure are not limited to the above-described effects, and other effects may exist.

### BRIEF DESCRIPTION OF THE DRAWINGS

FIG. 1 is a flowchart showing a method for manufacturing a ternary catalyst coated with a metal oxide according to one embodiment of the present disclosure.

FIG. 2 is a flowchart showing a step of preparing a ternary catalyst core according to one embodiment of the present disclosure.

FIG. 3 is a flowchart showing a step of forming a metal oxide shell on the ternary catalyst core according to one embodiment of the present disclosure.

FIG. 4 is a view showing methane and carbon dioxide conversion rates with respect to a methane dry reforming reaction time of catalysts according to examples and comparative examples of the present disclosure under various space velocity conditions.

FIGS. 5A to 5E are views showing STEM element diagramming images of the catalysts according to the examples and the comparative example of the present disclosure.

FIG. 6 is a view showing X-ray diffraction analysis results of the catalysts according to the examples and the comparative example of the present disclosure before reduction, after the reduction, and after a reaction.

FIG. 7 is a view showing a temperature-programmed reduction (TPR) result according to one experimental example of the present disclosure.

FIG. 8 is a view showing thermogravimetric analysis (TGA) results of the catalysts according to the examples and the comparative example of the present disclosure after the reaction.

FIG. 9 is a view showing a hydrogen-temperature-programmed surface reaction analysis result of the catalysts according to the examples and the comparative example of the present disclosure.

### DETAILED DESCRIPTION OF THE INVENTION

Hereinafter, embodiments of the present disclosure will be described in detail with reference to the accompanying drawings so that a person having ordinary skill in the art to which the present disclosure pertains may easily implement the present disclosure.

However, the present disclosure may be embodied in many different forms without being limited to the embodiments described herein. In addition, a portion irrelevant to the description will be omitted in the drawings in order to clearly describe the present disclosure, and like reference numerals will be used for like portions throughout the present disclosure.

Throughout the present disclosure, when a portion is described as being “connected” to another portion, the description includes both a case in which the portion is “directly connected” to the other portion and a case in which the portion is “electrically connected” to the other portion with another element interposed therebetween.

Throughout the present disclosure, when a member is described as being located “on”, “over”, “above”, “under”, “below”, or “beneath” another member, the description includes both a case in which the member makes contact with the other member and a case in which another member exists between the two members.

Throughout the present disclosure, when a portion is described as “including” an element, unless explicitly described to the contrary, the description means that other elements may be further included but not excluded.

As used herein, a term indicating a degree, such as “about” and “substantially”, is used to have a meaning close to or approximating a numerical value when unique manufacture and material tolerances are proposed to a disclosed content, and used to prevent an accurate or absolute numerical value provided to the disclosed content for better understanding of the present disclosure from being unfairly used by an unconscionable infringer. In addition, throughout the present disclosure, the term “step of . . . ” or “step in which . . . ” does not mean “step for . . . ”.

Throughout the present disclosure, the term “combination thereof” included in the expression of the Markush form means at least one mixture or combination selected from the group consisting of elements described in the expression of the Markush form, and means to include at least one selected from the group consisting of the above elements.

Throughout the present disclosure, the expression “A and/or B” means “A or B, or A and B”.

Hereinafter, a ternary catalyst coated with a metal oxide and a method for manufacturing the same according to the present disclosure will be described in detail with reference to embodiments, examples, and the drawings. However, the present disclosure is not limited to the embodiments, the examples, and the drawings.

As technical solutions for achieving the technical objects described above, according to a first aspect of the present disclosure, there is provided a ternary catalyst coated with a metal oxide, the ternary catalyst including: a ternary catalyst core including a hydrotalcite support and metal particles dispersed on the support; and a metal oxide shell formed on the ternary catalyst core.

According to the ternary catalyst coated with the metal oxide of the present disclosure, a catalyst prepared from a hydrotalcite precursor may be coated with various metal oxides such as ceria, zirconia, silica, and alumina so as to achieve a space confinement effect, so that deactivation of the catalyst caused by deposition of coke may be significantly suppressed by preventing agglomeration of metal particles (e.g., nickel particles), which are active materials, under dry reforming reaction conditions of a high temperature and a high space velocity. In addition, a catalyst having resistance against coke while ensuring high conversion rates for methane and carbon dioxide through a unique activity enhancement effect of the coated metal oxide may be provided.

According to one embodiment of the present disclosure, the metal particles may be present between the support and the metal oxide shell, but the embodiments are not limited thereto.

According to a conventional catalyst, activity of the catalyst was reduced by agglomeration of metal particles, which are active components of the catalyst, and formation of coke under dry reforming reaction conditions of a high temperature and a high space velocity. However, according to the catalyst of the present disclosure, the ternary catalyst core including the metal particles dispersed on the support may be coated with the metal oxide shell, so that the metal particles may be present between the shell and the support. Accordingly, a space confinement effect may be achieved so that sintering of the metal particles may be minimized, and deposition of coke may be reduced by a unique activity enhancement effect of the metal oxide shell so that overall activity of the catalyst may be improved.

According to one embodiment of the present disclosure, the metal oxide shell may include a pore having a size of less than 20 nm, but the embodiments are not limited thereto.

The ternary catalyst coated with the metal oxide according to the present invention may include the pore in the metal oxide shell, so that a reactant may smoothly penetrate into the shell so as to easily access an active site present inside the shell. In other words, the metal oxide shell may include the pore, so that mass transfer of a reactant and a product may be facilitated.

According to one embodiment of the present disclosure, the metal may include a metal selected from the group consisting of Ni, Cu, Co, Fe, Pt, Ru, Ir, Rh, and combinations thereof, but the embodiments are not limited thereto.

According to one embodiment of the present disclosure, the metal oxide may include a ceramic material selected from the group consisting of ceria (CeO₂), zirconia (ZrO₂), silica (SiO₂), alumina (Al₂O₃), titania (TiO₂), and combinations thereof, but the embodiments are not limited thereto.

In addition, according to a second aspect of the present disclosure, there is provided a method for manufacturing a ternary catalyst coated with a metal oxide, the method including: preparing a ternary catalyst core including a hydrotalcite support and metal particles dispersed on the support; and forming a metal oxide shell on the ternary catalyst core.

Although portions of detailed descriptions of the method for manufacturing the ternary catalyst coated with the metal oxide according to the second aspect of the present disclosure, which overlap the first aspect of the present disclosure, have been omitted, the contents described in the first aspect of the present disclosure may be identically applied to the second aspect of the present disclosure even though the description is omitted.

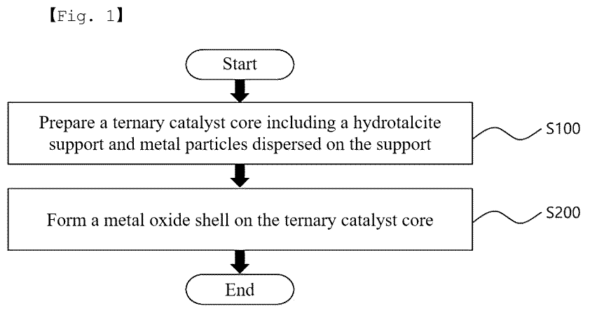

FIG. 1 is a flowchart showing a method for manufacturing a ternary catalyst coated with a metal oxide according to one embodiment of the present disclosure.

First, a ternary catalyst core including a hydrotalcite support and metal particles dispersed on the support may be prepared (S100).

According to one embodiment of the present disclosure, the preparing of the ternary catalyst core may include: preparing a mixed solution by dropping a metal precursor aqueous solution onto a basic aqueous solution; preparing powder by drying the mixed solution; and firing the powder, but the embodiments are not limited thereto.

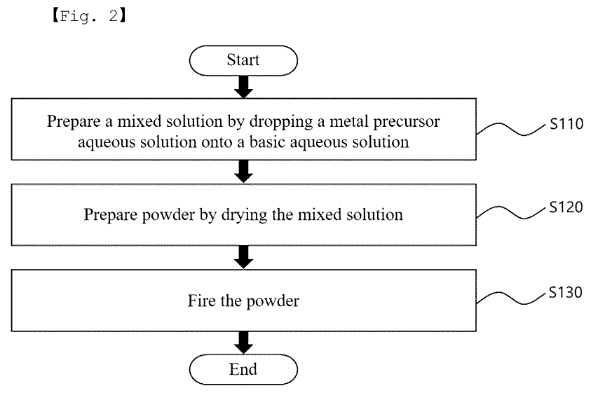

FIG. 2 is a flowchart showing a step of preparing a ternary catalyst core according to one embodiment of the present disclosure.

The preparing of the ternary catalyst core has been performed by synthesizing a hydrotalcite precursor by using a co-precipitation scheme and firing the synthesized hydrotalcite precursor.

First, a mixed solution may be prepared by dropping a metal precursor aqueous solution onto a basic aqueous solution (S110).

According to one embodiment of the present disclosure, the basic aqueous solution may be selected from the group consisting of sodium carbonate, calcium carbonate, magnesium carbonate, calcium hydroxide, magnesium hydroxide, barium hydroxide, potassium hydroxide, and combinations thereof, but the embodiments are not limited thereto.

According to one embodiment of the present disclosure, the metal precursor aqueous solution may include precursors of at least three metals selected from Al, Mg, Ni, Cu, Co, Fe, Pt, Ru, Ir, or Rh, but the embodiments are not limited thereto.

According to one embodiment of the present disclosure, the dropping may be performed under a basic condition, but the embodiments are not limited thereto.

As the metal precursor aqueous solution is dropped onto the basic aqueous solution, pH of the solution may be gradually decreased. In this case, a pH value of the solution may be monitored through pH test paper, and a basic solution such as a sodium hydroxide aqueous solution may be added to maintain basicity of the solution, but the embodiments are not limited thereto.

Thereafter, powder may be prepared by drying the mixed solution (S120).

After injection of the metal precursor aqueous solution into the basic aqueous solution is finished, the mixed solution may be stirred and aged. The solution that has been aged may be separated, washed, and dried, and a dried product may be ground to prepare the powder.

Finally, the powder may be fired (S130).

According to one embodiment of the present disclosure, the firing may be performed for 1 hour to 6 hours within a temperature range of 600° C. to 1,000° C., but the embodiments are not limited thereto.

When a firing temperature is too low, the hydrotalcite support may not be formed, and when the firing temperature is too high, the metal particles may be too large so that a specific surface area of the catalyst may be decreased. Therefore, the firing may be preferably performed for 1 hour to 6 hours within a temperature range of 600° C. to 1,000° C., but the embodiments are not limited thereto.

The powder may be fired, so that the ternary catalyst core including the hydrotalcite support and the metal particles dispersed on the support may be finally prepared.

Thereafter, a metal oxide shell may be formed on the ternary catalyst core (S200).

According to one embodiment of the present disclosure, the forming of the metal oxide shell may include: attaching a surfactant onto a surface of the ternary catalyst core; stirring the ternary catalyst core to which the surfactant is attached with a metal oxide precursor; and removing the surfactant, but the embodiments are not limited thereto.

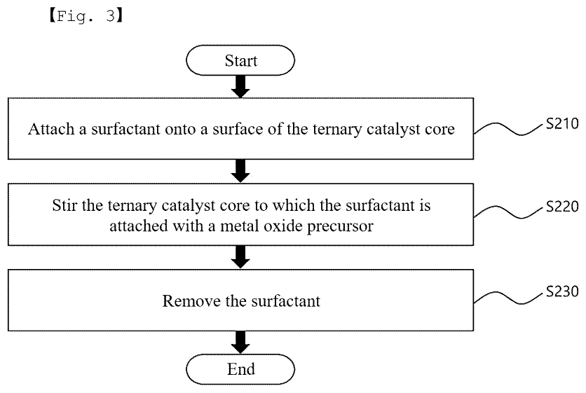

FIG. 3 is a flowchart showing a step of forming a metal oxide shell according to one embodiment of the present disclosure.

First, a surfactant may be attached onto a surface of the ternary catalyst core (S210).

The surfactant may be attached onto the surface of the ternary catalyst core by adding the surfactant to a solution containing the ternary catalyst core and subjecting the solution to an ultrasonic treatment, but the embodiments are not limited thereto.

According to one embodiment of the present disclosure, the surfactant may include a surfactant selected from the group consisting of cetyl trimethyl ammonium bromide, hexadecyl trimethyl ammonium bromide, cetyl trimethyl ammonium chloride, cetyl pyridinium chloride, benzalkonium chloride, benzethonium chloride, dioctadecyl dimethyl ammonium bromide, and combinations thereof, but the embodiments are not limited thereto.

Thereafter, the ternary catalyst core to which the surfactant is attached may be stirred with a metal oxide precursor (S220).

Descriptions will be given on whether the metal oxide precursor may be used to coat the surface of the catalyst core with a metal oxide through adding and stirring of the metal oxide precursor due to presence of the surfactant on the surface of the ternary catalyst core.

Since the surfactant is attached onto the surface of the ternary catalyst core, the metal oxide precursor may be easily attached onto the surface of the catalyst core. In detail, the surfactant attached onto the catalyst core may have a hydrophobic tail portion attached onto the surface of the catalyst core, so that when the metal oxide precursor is injected, the metal oxide precursor having hydrophobicity may be present on the tail portion of the surfactant, that is, the surface of the catalyst core. The metal oxide precursor present on the surface of the catalyst core may be subjected to a dehydration-condensation reaction through a stirring process, and finally, the surface of the catalyst core may be coated with the metal oxide so that the metal oxide shell may be formed.

According to one embodiment of the present disclosure, the metal oxide precursor may include a compound represented by Chemical Formula 1:

M-(ORₓ)_{y},
where M is Ce, Zr, Si, Al, or Ti,
x and y are numbers determined by an oxidation number of M,
R is optionally substituted linear or branched C₁-C₁₂ alkyl, optionally substituted C₃-C₁₂ cycloalkyl, or optionally substituted C₆-C₁₈ aryl, and
the substitution is performed by oxygen, nitrogen, sulfur, linear or branched C₁-C₆ alkyl, C₆-C₂₀ aryl, halogen, alkoxy, trimethyl silyl, ether, or a combination thereof, but the embodiments are not limited thereto.

Finally, the surfactant may be removed (S230).

The surfactant may be removed through firing, and a pore may be formed in a place in which the surfactant was present. Accordingly, the pore may be included in the metal oxide shell formed on the surface of the catalyst core, so that the mass transfer of the reactant and the product may be enabled.

The surfactant may be removed, so that the ternary catalyst coated with the metal oxide according to the present disclosure may be finally prepared.

In addition, according to a third aspect of the present disclosure, there is provided a catalyst for manufacturing a synthesis gas, the catalyst including a ternary catalyst coated with a metal oxide according to the first aspect of the present disclosure.

Although portions of detailed descriptions of the catalyst for manufacturing the synthesis gas according to the third aspect of the present disclosure, which overlap the first aspect of the present disclosure, have been omitted, the contents described in the first aspect of the present disclosure may be identically applied to the third aspect of the present disclosure even though the description is omitted.

The ternary catalyst coated with the metal oxide according to the present disclosure may be used as the catalyst for manufacturing the synthesis gas, so that a synthesis gas having a H₂/CO ratio that is ideally close to 1 may be prepared by a dry reforming reaction of methane and carbon dioxide, which are main components of a natural gas, a shale gas, or a biogas.

Hereinafter, the present invention will be described in more detail through examples. However, since the following examples have been provided for illustrative purposes only, the examples are not intended to limit the scope of the present disclosure.

### [Example 1] Preparation of Ternary Catalyst Coated with Ceria (Ni—Mg—Al@CeO₂)

An aqueous solution in which metal precursors are mixed was prepared by inserting 5.06 g of nickel nitrate hexahydrate, 37.00 g of magnesium nitrate hexahydrate, and 21.18 g of aluminum nitrate nonahydrate into 219 mL of DI water, performing an ultrasonic treatment for 30 minutes, and performing stirring for additional 30 minutes. In addition, 219 mL of the DI water and 23.22 g of sodium carbonate anhydride were injected into a three-necked flask, and stirring was performed at 600 rpm while increasing a temperature of the three-necked flask on a heating mantle.

When a temperature of a sodium carbonate aqueous solution reaches 60° C., the previously prepared aqueous solution in which the metal precursors are mixed is slowly injected by using a burette. As the aqueous solution in which the metal precursors are mixed is injected, pH in the three-necked flask is gradually decreased. In this case, a pH value of the solution was maintained at 10 by using the sodium hydroxide aqueous solution, and the pH value of the solution was monitored through pH test paper.

After the entire aqueous solution in which the metal precursors are mixed is injected, the solution in the three-necked flask was aged while being stirred at 60° C. for 24 hours. After 24 hours, the three-necked flask was removed from the heating mantle, and cooled at a room temperature. After the temperature of the three-necked flask is sufficiently decreased, the solution inside the three-necked flask was separated and washed by centrifugation using water. The centrifugation was performed a total of four times, in which each centrifugation was performed at 8,000 rpm for 5 minutes and 30 seconds. A suspension obtained after the centrifugation is performed was dried overnight in an oven at 100° C. A dried product was finely ground into powder, and fired at 800° C. for 4 hours (1° C./min) in an air atmosphere, so that a ternary catalyst core (Ni—Mg—Al) was prepared.

Thereafter, 1 g of the prepared Ni—Mg—Al was inserted into 9 mL of ethanol, and subjected to an ultrasonic treatment for 30 minutes. In addition, 0.3 g of cetyl trimethyl ammonium bromide (hereinafter referred to as “CTAB”), 0.6 mL of ammonia water, and 8 mL of ethanol were injected into the previously prepared solution, and an ultrasonic treatment was performed for additional 10 minutes so as to attach the CTAB to a surface of a catalyst.

After the solution that has been subjected to the ultrasonic treatment is stirred for 30 minutes, 2.92 g of cerium-2-methoxyethoxide was injected as a metal oxide precursor, and stirring was performed at 600 rpm for 20 hours. After the stirring, centrifugation was performed three times, in which each centrifugation was performed at 8,000 rpm for 10 minutes, and drying was performed overnight in an oven at 80° C. A dried product was fired at 550° C. for 2 hours in an air atmosphere so as to remove the CTAB.

### [Example 2] Preparation of Ternary Catalyst Coated with Zirconia (Ni—Mg—Al@ZrO₂)

Preparation was performed in the same manner as in Example 1, while 0.64 g of zirconium butoxide was injected as a metal oxide precursor.

### [Example 3] Preparation of Ternary Catalyst Coated with Silica (Ni—Mg—Al@SiO₂)

Preparation was performed in the same manner as in Example 1, while 0.3 mL of tetraethyl orthosilicate (TEOS) was injected as a metal oxide precursor.

### [Example 4] Preparation of Ternary Catalyst Coated with Alumina (Ni—Mg—Al@Al₂O₃)

Preparation was performed in the same manner as in Example 1, while 0.27 g of aluminum isopropoxide (AIP) was injected as a metal oxide precursor.

### [Comparative Example 1] Ternary Catalyst (Ni—Mg—Al)

A ternary catalyst (Ni—Mg—Al) that is not coated with a metal oxide was used as Comparative Example 1.

### [Comparative Example 2] Preparation of Ternary Catalyst Coated With Ceria (Ni—Mg—Al@CeO₂)

Preparation was performed in the same manner as in Example 1, while 1.54 g of cerium-2-methoxyethoxide was injected as a metal oxide precursor.

### [Comparative Example 3] Preparation of Ternary Catalyst Coated with Ceria (Ni—Mg—Al@CeO₂)

Preparation was performed in the same manner as in Example 1, while 4.61 g of cerium-2-methoxyethoxide was injected as a metal oxide precursor.

### [Comparative Example 4] Preparation of Ternary Catalyst Coated with Zirconia (Ni—Mg—Al@ZrO₂)

Preparation was performed in the same manner as in Example 2, while 0.21 g of zirconium butoxide was injected as a metal oxide precursor.

### [Comparative Example 5] Preparation of Ternary Catalyst Coated with Zirconia (Ni—Mg—Al@ZrO₂)

Preparation was performed in the same manner as in Example 2, while 1.06 g of zirconium butoxide was injected as a metal oxide precursor.

### [Comparative Example 6] Preparation of Ternary Catalyst Coated with Alumina (Ni—Mg—Al@Al₂O₃)

Preparation was performed in the same manner as in Example 4, while 0.91 g of aluminum isopropoxide (AIP) was injected as a metal oxide precursor.

### [Comparative Example 7] Preparation of Ternary Catalyst Coated with Alumina (Ni—Mg—Al@Al₂O₃)

Preparation was performed in the same manner as in Example 4, while 1.37 g of aluminum isopropoxide (AIP) was injected as a metal oxide precursor.

### [Experimental Example 1] Methane Dry Reforming Reaction Activity Experiment

A methane dry reforming reaction was performed at 800° C. and 1 atmospheric pressure, and a ⅜-inch Inconel reactor was used for a reactivity test. The reactor was placed in an electric furnace, and 50 mg of a catalyst was used. Before a reaction, the catalyst was reduced at a temperature of 850° C. for 1 hour while flowing 5 vol % of a H₂/N₂ gas at 30 ccm, and as soon as the reduction was finished, a methane-carbon dioxide-nitrogen gas in which a molar ratio of methane:carbon dioxide:nitrogen is 1:1:2 was flowed under conditions of space velocities of 38,000 L/kg_{cat}/h and 380,000 L/kg_{cat}/h. The reaction was continuously performed for 20 hours, and a gas discharged through the reactor was analyzed through a thermal conductivity detector (TCD) mounted on a gas chromatograph.

Tables 1a and 1b below show results of the methane dry reforming reaction activity experiment according to one experimental example of the present disclosure.

TABLE 1a

| | | | | Methane conversion | | Carbon dioxide | |
|---|---|---|---|---|---|---|---|
| | | | | rate (mol %) | | conversion rate (mol %) | |
| | | | | After 1 | After 20 | After 1 | After 20 |
| Classification | Catalyst name | Space velocity | | hour | hours | hour | hours |
| Example 1 | Ni—Mg—Al@CeO₂ | 38000 | L/Kg_{cat}/h | 93.9 | 93.4 | 90.3 | 89.5 |
| | | 380000 | L/Kg_{cat}/h | 61.3 | 60.0 | 73.6 | 72.8 |
| Example 2 | Ni—Mg—Al@ZrO₂ | 38000 | L/Kg_{cat}/h | 92.8 | 92.2 | 89.6 | 88.9 |
| | | 380000 | L/Kg_{cat}/h | 56.0 | 54.8 | 70.0 | 69.0 |
| Example 3 | Ni—Mg—Al@SiO₂ | 38000 | L/Kg_{cat}/h | 92.2 | 92.2 | 89.6 | 89.4 |
| | | 380000 | L/Kg_{cat}/h | 51.4 | 50.5 | 66.4 | 65.5 |
| Example 4 | Ni—Mg—Al@Al₂O₃ | 38000 | L/Kg_{cat}/h | 95.5 | 95.4 | 91.6 | 91.4 |
| | | 380000 | L/Kg_{cat}/h | 60.7 | 60.9 | 73.7 | 74.2 |
| Comparative | Ni—Mg—Al | 38000 | L/Kg_{cat}/h | 91.2 | 90.9 | 88.7 | 88.1 |
| Example 1 | | 380000 | L/Kg_{cat}/h | 41.9 | 40.4 | 56.5 | 55.3 |

TABLE 1b

| | | | Methane conversion | | Carbon dioxide | |
|---|---|---|---|---|---|---|
| | | | rate (mol %) | | conversion rate (mol %) | |
| | | | After 1 | After 20 | After 1 | After 20 |
| Classification | Catalyst name | Space velocity | hour | hours | hour | hours |
| Example 1 | Ni—Mg—Al@CeO₂ | 380000 | 61.3 | 60.0 | 73.6 | 72.8 |
| Comparative Example 2 | Ni—Mg—Al@CeO₂ | L/Kg_{cat}/h | 57.0 | 53.7 | 70.4 | 67.9 |
| Comparative Example 3 | Ni—Mg—Al@CeO₂ | | 45.5 | 44.3 | 61.5 | 60.6 |
| Example 2 | Ni—Mg—Al@ZrO₂ | | 56.0 | 54.8 | 70.0 | 69.0 |
| Comparative Example 4 | Ni—Mg—Al@ZrO₂ | | 59.4 | 54.6 | 71.1 | 67.5 |
| Comparative Example 5 | Ni—Mg—Al@ZrO₂ | | 45.0 | 43.2 | 60.2 | 58.3 |
| Example 4 | Ni—Mg—Al@Al₂O₃ | | 60.7 | 60.9 | 73.7 | 74.2 |
| Comparative Example 6 | Ni—Mg—Al@Al₂O₃ | | 53.1 | 47.9 | 67.5 | 63.0 |
| Comparative Example 7 | Ni—Mg—Al@Al₂O₃ | | 47.0 | 45.5 | 62.1 | 60.7 |
| Comparative Example 1 | Ni—Mg—Al | | 41.9 | 40.4 | 56.5 | 55.3 |

The results of Tables 1a and 1b were calculated through Formulas 1 and 2 below, and a conversion rate of each reactant within the gas after the reaction was calculated in comparison with a total amount of each reactant within the gas before the reaction.

$$Methane conversion rate ( mol \% ) = ( 1 - \frac{{F}_{{CH}_{4} , out}}{{F}_{{CH}_{4} , in}} ) \times 100 \qquad [ Formula 1 ]$$

$$Carbon dioxide conversion rate ( mol \% ) = ( 1 - \frac{{F}_{{CO}_{2} , out}}{{F}_{{CO}_{2} , in}} ) \times 100 \qquad [ Formula 2 ]$$

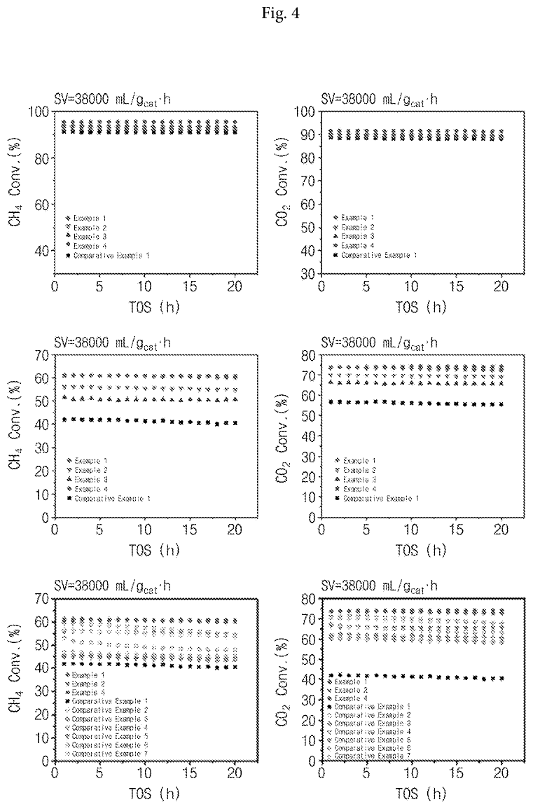

FIG. 4 is a view showing methane and carbon dioxide conversion rates with respect to a methane dry reforming reaction time of catalysts according to examples and comparative examples of the present disclosure under various space velocity conditions.

Referring to Table 1a and FIG. 4, in was found that methane dry reforming reaction activity of the catalysts according to the examples of the present disclosure is configured such that both a methane conversion rate and a carbon dioxide conversion rate are close to an equilibrium conversion rate under a condition of a relatively low space velocity of 38,000 L/kg_{cat}/h, whereas the activity of the catalysts is rapidly decreased when the space velocity is increased to 380,000 L/kg_{cat}/h.

However, it was found that under a condition of a space velocity of 380,000 L/kg_{cat}/h, in a case of Comparative Example 1, the methane conversion rate and the carbon dioxide conversion rate after hours of reaction are 40.4% and 55.3%, respectively, whereas in a case of the catalyst coated with the metal oxide according to Example 4, the methane conversion rate and the carbon dioxide conversion rate after 20 hours of reaction are maintained to be about 10% to 20% higher than that of the catalyst according to Comparative Example 1. This difference in reactivity is considered to be caused by a space confinement effect on nickel particles provided by the coated metal oxide as well as a unique catalyst activity enhancement effect of the metal oxide.

Meanwhile, the ternary catalyst coated with the ceria, that is, Example 1, Comparative Example 2, and Comparative Example 3 will be reviewed with reference to Table 1 b and FIG. 4.

Referring to Table 1 b and FIG. 4, it was found that the methane conversion rate and the carbon dioxide conversion rate are higher in Example 1 (2.92 g) in which a larger amount of cerium-2-methoxyethoxide is injected as compared with Comparative Example 2 (1.54 g). Meanwhile, it may be observed that the methane conversion rate and the carbon dioxide conversion rate are lowered in Comparative Example 3 (4.61 g) in which a larger amount of cerium-2-methoxyethoxide is injected as compared with Example 1 (2.92 g).

Accordingly, it was found that when the ternary catalyst is coated with the ceria, there is a critical value in an injection amount of the cerium-2-methoxyethoxide. According to Example 1, critical significance may be obtained when the injection amount of the cerium-2-methoxyethoxide is greater than 1.54 g and less than 4.61 g.

### [Experimental Example 2] Analysis of Physical Properties of Catalyst

In order to analyze physical properties of the catalysts according to the examples and the comparative example of the present disclosure, X-ray fluorescence analysis (XRF), nitrogen physical adsorption/desorption (N₂-physisorption) analysis, and X-ray diffraction analysis were performed.

Table 2 below shows results of analyzing the physical properties of the catalysts according to the examples and the comparative example of the present disclosure.

TABLE 2

| | | | | | Nitrogen physisorption | | | Nickel crystal size | |
|---|---|---|---|---|---|---|---|---|---|
| | XRF (wt %) | | | | Specific | Pore | Pore | After | After |
| | | | | Coated | surface area | diameter | volume | reduction | reaction |
| Classification | Ni | Mg | Al | metal | (m²/g) | (nm) | (cm³/g) | (nm) | (nm) |
| Example 1 | 14.5 | 30.1 | 11.2 | 14.9 | 115 | 19.6 | 0.45 | 10.4 | 9.8 |
| Example 2 | 12.7 | 25.5 | 11.3 | 10.8 | 134 | 15.1 | 0.57 | 10.3 | 10.6 |
| Example 3 | 14.5 | 29.7 | 13.9 | 3.5 | 138 | 15.4 | 0.59 | 10.8 | 11.9 |
| Example 4 | 14.5 | 29.2 | 16.7 | 3.0 | 137 | 16.9 | 0.61 | 10.7 | 11.6 |
| Comparative | 15.5 | 31.9 | 14.9 | — | 114 | 22.0 | 0.59 | 12.7 | 14.1 |
| Example 1 | | | | | | | | | |

Referring to Table 2, as a result of performing the X-ray fluorescence analysis to confirm a composition of atoms in the catalyst, it was found that the surfaces of the catalysts according to Examples are coated with the metal oxide so that all the catalysts according to Examples exhibit lower wt % of nickel and magnesium than the catalyst according to Comparative Example, which is not coated with the metal oxide. According to the catalysts of Examples 1 to 3, wt % of ceria, zirconia, and silica were 14.9 wt %, 10.8 wt %, and 3.5 wt %, respectively, and since coated metals are injected in equimolar amounts, it was found that wt % of the coated metal is proportional to an atomic weight of a metal.

In addition, referring to Table 2, according to the results of nitrogen adsorption/desorption for confirming a specific surface area, an average pore diameter, and a pore volume of the catalyst, Example 1 had a specific surface area of 115 m²/g that is similar to 114 m²/g, which is a specific surface area of the catalyst according to Comparative Example 1, which is not coated. Meanwhile, the catalysts according to Examples 2 to 4 had increased specific surface areas of 134 m²/g and 138 m²/g, respectively, which represents that zirconia, silica, and alumina are widely and excellently dispersed on a surface of a parent catalyst. This can be confirmed through STEM element diagramming images.

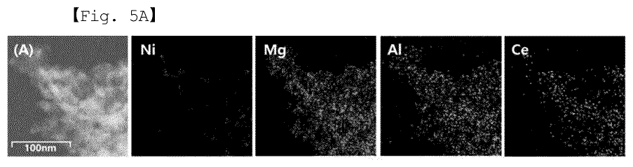

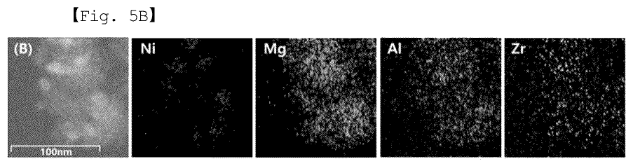

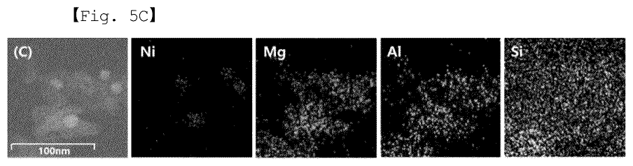

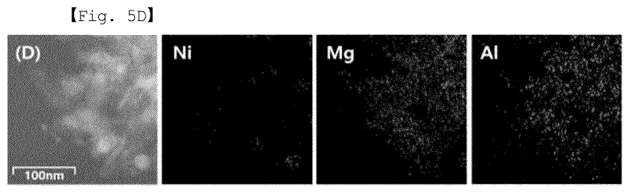

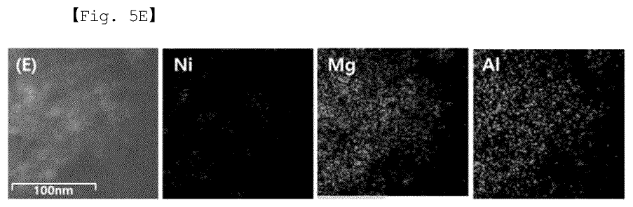

FIGS. 5A to 5E are views showing STEM element diagramming images of the catalysts according to the examples and the comparative example of the present disclosure. In detail, FIGS. 5A, 5C, 5D, and 5E are STEM element diagramming images of Example 1, Example 2, Example 3, Example 4, and Comparative Example 1, respectively.

Referring to FIGS. 5A to 5E, as can be seen from the element image of the catalyst according to Example 1, the coated ceria metal oxide represented in yellow has a shape similar to the entire skeletal structure of the catalyst, and thus it can be deduced that the Ni—Mg—Al@CeO₂ catalyst according to Example 1 and the Ni—Mg—Al catalyst according to Comparative Example 1, which was not coated, have similar specific surface areas of 115 m²/g and 114 m²/g, respectively. Meanwhile, it can be confirmed that the coated zirconia, silica, and alumina metal oxides shown in yellow or cyan color in the element images of the catalysts of Examples 2 to 4 are widely dispersed in a shape different from the skeletal structure of the catalyst, and such dispersibility results in wide specific surface areas of 134, 138, and 137, respectively.

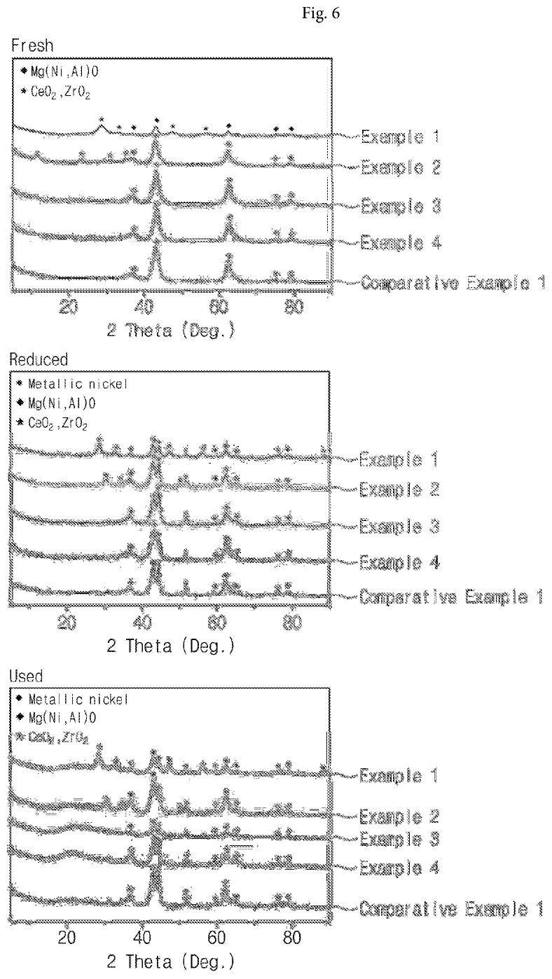

FIG. 6 is a view showing X-ray diffraction analysis results of the catalysts according to the examples and the comparative example of the present disclosure before reduction, after the reduction, and after a reaction.

The X-ray diffraction analysis was performed using Cu-Kα radiation at 0.15406 nm. In the case of the catalyst after reduction, the X-ray diffraction analysis was performed with respect to the catalyst that is reduced under the condition that 5 vol % H₂/N₂ flows at 850° C. for 1 hour, and in the case of the catalyst after reaction, the X-ray diffraction analysis was performed with respect to the catalyst that is retrieved after performing dry reforming reaction for 20 hours under the conditions of 800° C. and a space velocity of 380,000 L/kg_{cat}/h.

Referring to Table 2 and FIG. 6, as a result of the X-ray diffraction analysis for confirming metal crystals in the catalyst and analyzing a crystal size of nickel particles, it was confirmed that the nickel crystal sizes of the catalysts of Examples 1 to 4 coated with a metal oxide were all smaller than that of the catalyst according to Comparative Example 1 after reduction and after 20 hours of reaction, and this is resulted from the fact that the nickel particles were prevented from being sintered during the reduction and methane dry reforming reaction process performed at a high temperature because the nickel particles were confined between the support and the shell by the coated metal oxide. This may be confirmed through a temperature-programmed reduction (TPR) result.

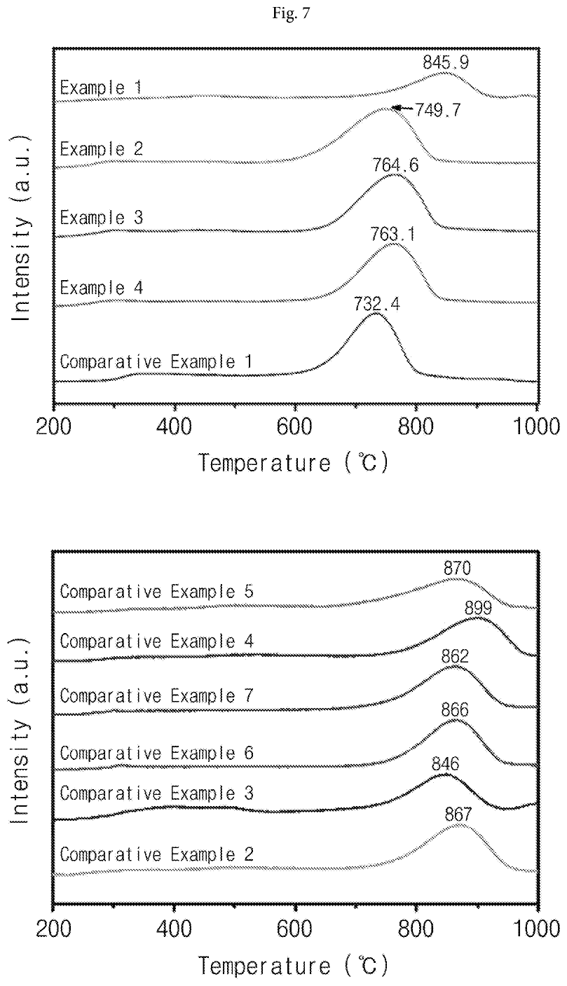

FIG. 7 is a view showing a temperature-programmed reduction (TPR) result according to one experimental example of the present disclosure.

The H₂-TPR analysis was performed using BELCAT-M (MicrotracBEL) to determine the degree of interaction of nickel particles, which are present in the catalyst, between a support and a metal oxide shell.

Before the analysis, residual oxygen and moisture in the catalyst were removed under conditions that 30 ccm of argon flowed at 350° C. Then 10 vol % H₂/N₂ gas was injected and the temperature was raised from 100° C. to 1,000° C. at a rate of 10° C./min. The amount of consumed hydrogen was analyzed through a thermal conductivity detector attached to the equipment.

Referring to FIG. 7, it may be confirmed that the catalysts of Examples 1 to 4 all exhibited reduction peaks of nickel species at a higher temperature than the catalyst according to Comparative Example 1. In general, in the TPR analysis, the reduction peak of the nickel species is moved to a higher temperature because the nickel strongly interacts with the support, and such a temperature movement phenomenon may also be confirmed from FIG. 7.

### [Experimental Example 3] Analysis of Coke Formed after Dry Reforming Reaction of Methane

The thermogravimetric analysis (TGA) and temperature programmed surface reaction spectroscopy (TPSR) analysis were performed to analyze the amount of coke deposited on the catalyst after the reaction.

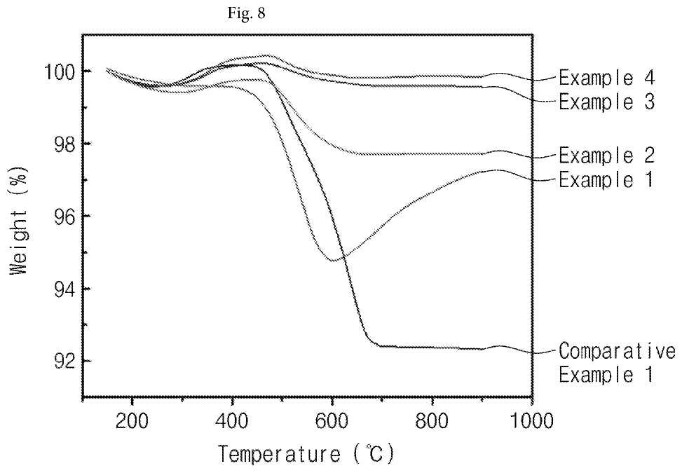

FIG. 8 is a view showing thermogravimetric analysis (TGA) results of the catalysts according to the examples and the comparative example of the present disclosure after the reaction.

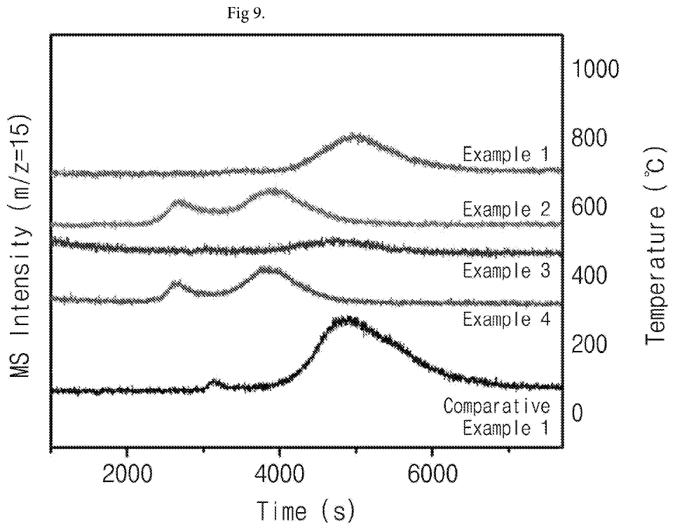

FIG. 9 is a view showing a hydrogen-temperature-programmed surface reaction analysis result of the catalysts according to the examples and the comparative example of the present disclosure.

Referring to FIGS. 8 and 9, the weight reduction according to the combustion of carbon deposited on the surface of the catalyst can be confirmed from the vicinity of 450° C. of the TGA graph, and the amount of methane production corresponding to the peak of m/z=15 of the mass spectrometer according to the surface reaction of carbon and hydrogen on the surface of the catalyst can be confirmed between 200° C. to 700° C. in the hydrogen TPSR graph.

The catalysts of Examples 1 to 4 show a lower weight reduction and a lower methane peak than the catalyst according to Comparative Example 1, and thus it may be confirmed that the coated metal oxide inhibited carbon deposition on the surface of the catalyst.

The above description of the present disclosure have been provided for illustrative purposes, and in will be understood by a person having ordinary skill in the art to which the present disclosure pertains that the present disclosure can be easily modified into other specific forms without changing the technical idea or essential characteristics of the present disclosure. Therefore, the embodiments described above are illustrative in all aspects, and shall not be construed as limiting. For example, each element described in a single form may be implemented in a distributed manner, and similarly, elements described as being distributed may be implemented in a combined form.

The scope of the present disclosure is defined by the following claims rather than the detailed description, and all changes or modifications derived from the meaning and scope of the claims and equivalent concepts thereof are construed as being included in the scope of the present disclosure.

What is claimed is:

1. A ternary catalyst coated with a metal oxide, the ternary catalyst comprising:
a ternary catalyst core including a hydrotalcite support and metal particles dispersed on the support; and
a metal oxide shell formed on the ternary catalyst core.

2. The ternary catalyst of claim 1, wherein the metal particles are present between the support and the metal oxide shell.

3. The ternary catalyst of claim 1, wherein the metal oxide shell includes a pore having a size of less than 20 nm.

4. The ternary catalyst of claim 1, wherein the metal includes a metal selected from the group consisting of Ni, Cu, Co, Fe, Pt, Ru, Ir, Rh, and combinations thereof.

5. The ternary catalyst of claim 1, wherein the metal oxide includes a ceramic material selected from the group consisting of ceria (CeO₂), zirconia (ZrO₂), silica (SiO₂), alumina (Al₂O₃), titania (TiO₂), and combinations thereof.

6. A method for manufacturing a ternary catalyst coated with a metal oxide, the method comprising:
preparing a ternary catalyst core including a hydrotalcite support and metal particles dispersed on the support; and
forming a metal oxide shell on the ternary catalyst core.

7. The method of claim 6, wherein the preparing of the ternary catalyst core includes:
preparing a mixed solution by dropping a metal precursor aqueous solution onto a basic aqueous solution;
preparing powder by drying the mixed solution; and
firing the powder.

8. The method of claim 7, wherein the dropping is performed under a basic condition.

9. The method of claim 7, wherein the metal precursor aqueous solution includes precursors of at least three metals selected from Al, Mg, Ni, Cu, Co, Fe, Pt, Ru, Ir, or Rh.

10. The method of claim 7, wherein the basic aqueous solution is selected from the group consisting of sodium carbonate, calcium carbonate, magnesium carbonate, calcium hydroxide, magnesium hydroxide, barium hydroxide, potassium hydroxide, and combinations thereof.

11. The method of claim 7, wherein the firing is performed for 1 hour to 6 hours within a temperature range of 600° C. to 1000° C.

12. The method of claim 6, wherein the forming of the metal oxide shell includes:
attaching a surfactant onto a surface of the ternary catalyst core;
stirring the ternary catalyst core to which the surfactant is attached with a metal oxide precursor; and
removing the surfactant.

13. The method of claim 12, wherein the surfactant includes a surfactant selected from the group consisting of cetyl trimethyl ammonium bromide, hexadecyl trimethyl ammonium bromide, cetyl trimethyl ammonium chloride, cetyl pyridinium chloride, benzalkonium chloride, benzethonium chloride, dioctadecyl dimethyl ammonium bromide, and combinations thereof.

14. The method of claim 12, wherein the metal oxide precursor includes a compound represented by Chemical Formula 1:
M-(ORₓ)_{y},
where M is Ce, Zr, Si, Al, or Ti,
x and y are numbers determined by an oxidation number of M,
R is optionally substituted linear or branched C₁-C₁₂ alkyl, optionally substituted C₃-C₁₂ cycloalkyl, or optionally substituted C₆-C₁₈ aryl, and
the substitution is performed by oxygen, nitrogen, sulfur, linear or branched C₁-C₆ alkyl, C₆-C₂₀ aryl, halogen, alkoxy, trimethyl silyl, ether, or a combination thereof.

15. The method of claim 14, wherein, when the M is the Ce, the ternary catalyst core is stirred with more than 1.54 g and less than 4.61 g of the metal oxide precursor.

16. A catalyst for manufacturing a synthesis gas, the catalyst comprising a ternary catalyst coated with a metal oxide, the ternary catalyst comprising:
a ternary catalyst core including a hydrotalcite support and metal particles dispersed on the support; and
a metal oxide shell formed on the ternary catalyst core.

17. The catalyst of claim 16, wherein the metal particles are present between the support and the metal oxide shell.

18. The catalyst of claim 16, wherein the metal oxide shell includes a pore having a size of less than 20 nm.

19. The catalyst of claim 16, wherein the metal includes a metal selected from the group consisting of Ni, Cu, Co, Fe, Pt, Ru, Ir, Rh, and combinations thereof.

20. The catalyst of claim 16, wherein the metal oxide includes a ceramic material selected from the group consisting of ceria (CeO₂), zirconia (ZrO₂), silica (SiO₂), alumina (Al₂O₃), titania (TiO₂), and combinations thereof.
